(19) United States
(12) Patent Application Publication
(10) Pub. No.: US 2023/0245257 A1
(43) Pub. Date: Aug. 3, 2023

(54) SKILL ASSESSMENT TO DETERMINE STUDENT PLACEMENT

(71) Applicant: Coding DoJo, Inc., Seattle, WA (US)

(72) Inventors: Jessi Chartier, Chicago, IL (US); Marisa Goode, Gainesville, VA (US); Amanda J. Russell, Renton, WA (US); Todd Enders, Vancouver, WA (US)

(21) Appl. No.: 18/162,209

(22) Filed: Jan. 31, 2023

Related U.S. Application Data
(60) Provisional application No. 63/305,042, filed on Jan. 31, 2022.

(51) Int. Cl. G06Q 50/20; G09B 7/00

(52) U.S. Cl. CPC G06Q 50/2053; G09B 7/00

(57) ABSTRACT

Systems and methods are presented for providing a user, such as an incoming student, with guidance for the attending the suitable preparatory course based on the answers provided by the student to an assessment of skills and learning styles. In one embodiment, an incoming student can be provided with an individualized learning profile based on the answers provided by the student to an assessment of skills and learning styles. Proper alignment can be ensured between an incoming student and program offerings based at least in part on the answers provided by the student to an assessment of skills and learning styles.

### CLAIM OF PRIORITY

This application claims the benefit of U.S. Provisional Application No. 63/305,042 titled “SKILL ASSESSMENT TO DETERMINE STUDENT PLACEMENT,” filed Jan. 31, 2022, the entire contents of which is incorporated herein by reference.

### FIELD OF THE DISCLOSURE

The present disclosure relates to systems and methods for using answers provided by students to an assessment of skills and learning styles to generate personal guidance on suitable preparatory courses, create an individualized learning profile, and ensure proper alignment between an incoming student and program offerings.

### BACKGROUND

As the ability to improve the customization of educational programs increases and the availability of a large pool of diverse students becomes more common, assessing students' capability becomes ever more important. In order to accurately determine the placement of student into an education program, a skill assessment can be utilized. Gaining data from a skill assessment allows for a student to be categorized according to any number of criteria determined to be relevant. Gaining data to better understand an individual students and customizing a student's experience by customizing the educational program for them based on an assessment, can improve a student's likelihood to succeed. In order to ensure that relevant and accurate information is gathered, a skill assessment can be tailored based on the questions posed to students and the format in which answers are provided. Such an approach can provide for a more efficient process and improved outcomes for students. However, if the information gathered from the assessment is not applied effectively, the benefits can be neutralized, providing a less than optimal experience. Additionally, an assessment to determine the placement of an individual in a program may be used for any number of programs, and is not limited to educational programs.

### BRIEF DESCRIPTION OF THE DRAWINGS

Various embodiments in accordance with the present disclosure will be described with reference to the drawings, in which:

FIG. 1 illustrates an example asset information management system that can be utilized in accordance with various embodiments;

FIG. 2 illustrates an example set of indicators and weights of a skill assessment, according to at least one embodiment;

FIG. 3 illustrates an alternative example set of indicators and weights of a skill assessment, according to at least one embodiment;

FIGS. 4A-D illustrate an example set of skill assessment questions and answers, according to at least one embodiment;

FIG. 5A-C illustrates an alternative example set of skill assessment questions and answers, according to at least one embodiment;

FIGS. 6A-C illustrate an example set of results of a completed skill assessment survey, according to at least one embodiment;

FIG. 7 illustrates an example skill assessment color legend, according to at least one embodiment;

FIGS. 8A and 8B illustrate an example set of skill assessment strengths and risks language, according to at least one embodiment;

FIGS. 9A and 9B illustrate an example student learning profile and detailed learning guide produced from a completed skill assessment, according to at least one embodiment; and

FIG. 10 illustrates components of an example computing device that can be used to perform operations in accordance with various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

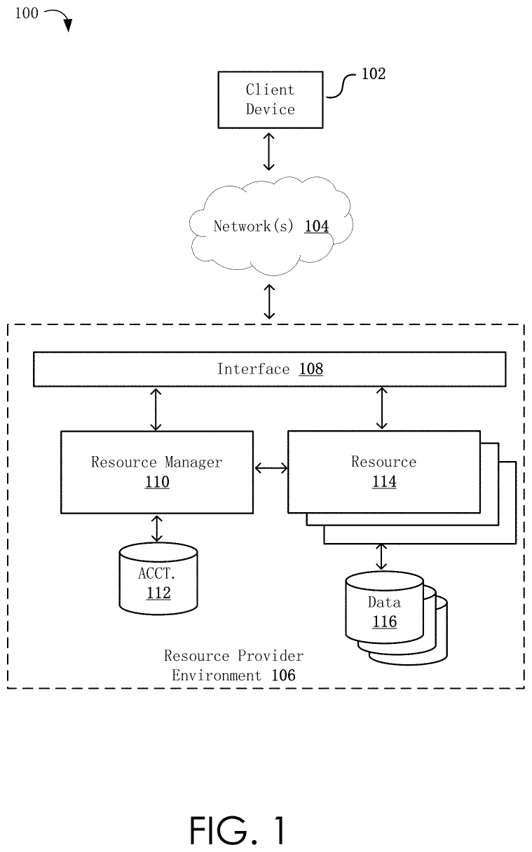

FIG. 1 illustrates an example environment 100 in which aspects of the various embodiments can be implemented. In this example an applicant is able to utilize a client device 102 to submit a completed assessment across at least one network 104 to a multi-tenant resource provider environment 106. A server 114 can execute an assessment application to process the assessment and make recommendations. A database 116 can store the results from the executed assessment application. The client device 102 can include any appropriate electronic device operable to send and receive requests, messages, or other such information over an appropriate network and convey information back to a user of the device. Examples of such client devices include personal computers, tablet computers, smart phones, notebook computers, and the like. The at least one network 104 can include any appropriate network, including an intranet, the Internet, a cellular network, a local area network (LAN), or any other such network or combination, and communication over the network can be enabled via wired and/or wireless connections. The resource provider environment 106 can include any appropriate components for receiving requests and returning information or performing actions in response to those requests. As an example, the provider environment might include Web servers and/or application servers for receiving and processing requests, then returning data, Web pages, video, audio, or other such content or information in response to the request.

In various embodiments, the provider environment may include various types of resources that can be utilized by multiple users for a variety of different purposes. As used herein, computing and other electronic resources utilized in a network environment can be referred to as “network resources.” These can include, for example, servers, databases, load balancers, routers, and the like, which can perform tasks such as to receive, transmit, and/or process data and/or executable instructions. In at least some embodiments, all or a portion of a given resource or set of resources might be allocated to a particular user or allocated for a particular task, for at least a determined period of time. The sharing of these multi-tenant resources from a provider environment is often referred to as resource sharing, Web services, or “cloud computing,” among other such terms and depending upon the specific environment and/or implementation. In this example the provider environment includes a plurality of resources 114 of one or more types. These types can include, for example, application servers operable to process instructions provided by a user or database servers operable to process data stored in one or more data stores 116 in response to a user request. As known for such purposes, the user can also reserve at least a portion of the data storage in a given data store. Methods for enabling a user to reserve various resources and resource instances are well known in the art, such that detailed description of the entire process, and explanation of all possible components, will not be discussed in detail herein.

In at least some embodiments, a user wanting to utilize a portion of the resources 114 can submit a request that is received to an interface layer 108 of the provider environment 106. The interface layer '08 can include application programming interfaces (APIs) or other exposed interfaces enabling a user to submit requests to the provider environment. The interface layer 108 in this example can also include other components as well, such as at least one Web server, routing components, load balancers, and the like. When a request to provision a resource is received to the interface layer 108, information for the request can be directed to a resource manager 110 or other such system, service, or component configured to manage user accounts and information, resource provisioning and usage, and other such aspects. A resource manager 110 receiving the request can perform tasks such as to authenticate an identity of the user submitting the request, as well as to determine whether that user has an existing account with the resource provider, where the account data may be stored in at least one data store 112 in the provider environment. A user can provide any of various types of credentials in order to authenticate an identity of the user to the provider. These credentials can include, for example, a username and password pair, biometric data, a digital signature, or other such information. The provider can validate this information against information stored for the user. If the user has an account with the appropriate permissions, status, etc., the resource manager can determine whether there are adequate resources available to suit the user's request, and if so can provision the resources or otherwise grant access to the corresponding portion of those resources for use by the user for an amount specified by the request. This amount can include, for example, capacity to process a single request or perform a single task, a specified period of time, or a recurring/renewable period, among other such values. If the user does not have a valid account with the provider, the user account does not enable access to the type of resources specified in the request, or another such reason is preventing the user from obtaining access to such resources, a communication can be sent to the user to enable the user to create or modify an account, or change the resources specified in the request, among other such options.

Once the user is authenticated, the account verified, and the resources allocated, the user can utilize the allocated resource(s) for the specified capacity, amount of data transfer, period of time, or other such value. In at least some embodiments, a user might provide a session token or other such credentials with subsequent requests in order to enable those requests to be processed on that user session. The user can receive a resource identifier, specific address, or other such information that can enable the client device 102 to communicate with an allocated resource without having to communicate with the resource manager 110, at least until such time as a relevant aspect of the user account changes, the user is no longer granted access to the resource, or another such aspect changes.

The resource manager 110 (or another such system or service) in this example can also function as a virtual layer of hardware and software components that handles control functions in addition to management actions, as may include provisioning, scaling, replication, etc. The resource manager can utilize dedicated APIs in the interface layer 108, where each API can be provided to receive requests for at least one specific action to be performed with respect to the data environment, such as to provision, scale, clone, or hibernate an instance. Upon receiving a request to one of the APIs, a Web services portion of the interface layer can parse or otherwise analyze the request to determine the steps or actions needed to act on or process the call. For example, a Web service call might be received that includes a request to create a data repository.

An interface layer 108 in at least one embodiment includes a scalable set of customer-facing servers that can provide the various APIs and return the appropriate responses based on the API specifications. The interface layer also can include at least one API service layer that in one embodiment consists of stateless, replicated servers which process the externally-facing customer APIs. The interface layer can be responsible for Web service front end features such as authenticating customers based on credentials, authorizing the customer, throttling customer requests to the API servers, validating user input, and marshalling or unmarshalling requests and responses. The API layer also can be responsible for reading and writing database configuration data to/from the administration data store, in response to the API calls. In many embodiments, the Web services layer and/or API service layer will be the only externally visible component, or the only component that is visible to, and accessible by, customers of the control service. The servers of the Web services layer can be stateless and scaled horizontally as known in the art. API servers, as well as the persistent data store, can be spread across multiple data centers in a region, for example, such that the servers are resilient to single data center failures.

A skill assessment system accordance with at least one embodiment can use a psychometric assessment that may use a questionnaire to elicit answers from a user, such as an incoming student, in order to determine aspects such as the individual capabilities, qualities, and/or needs of the student. The assessment can be analyzed, such as by a computing system executing an assessment application, and the results of the assessment can be provided to a placement measure system which processes the results. The placement measure system can be configured to identify the content and learning needs of users, such as incoming students. Based at least in part on these identified qualities, recommendations for the student can be determined and provided in regards to the program the student has chosen to enter. A skill assessment system can then automatically identify the content and learning needs of incoming students to best align program offerings to their needs.

Based at least in part on the completed analysis of a student's assessment results, the student may be directed to complete either a self-paced preparatory course or join a live preparatory course before taking the offered educational program. Depending on the results of the analysis, in some instances the student may not be directed to either preparatory course before taking the offer educational program, instead being directed to start the program immediately. Any other suitable directions may be given to a student based on the results of the assessment in order to improve the students outcome in relation to the educational program. Any other outcome may be recommended based on the desired purpose of the assessment. In another instance, the students may be directed to different preparatory course before beginning a full-time learning program. An assessment in any embodiment as described herein may be used for any number of programs, and is not limited to students and/or educational programs. The determinations made based on the assessment can be inferred using a trained machine learning model.

It should be understood that the questions of the assessment can be updated based on the needs of the system in order to better place students. Updates to the question can include a refinement of the psychometrics the assessment is based on in order to improve the validity and reliability of the assessment. In another instance, the types of answers the students can provide, or the options the student have to choose from in response to some questions, specific questions, or the order of questions can be similarly updated.

In some instances, a student may receive a personalized report based on the results of their completed assessment. The report may include a learning profile and/or a detailed learning guide. A student may also be given a personalized report based on the results of the placement measure process after analyzing the results. The personalized report may include a learning profile for the student. The personal report may outline the strengths and weaknesses of the student and how they should leverage the strengths and mitigate the weaknesses in actionable ways throughout the program. In one example, the learning profile may include catalytic skills, processing preference, and content consumption preferences. In other versions, more or less information can be provided. The learning profile is designed to allow the student and the instructions staff to at least better understand what resources to leverage when the student requires assistance or has difficulties in a certain area of the educational program. The personalized report is expected to empower students with the self-knowledge of the profiles provided by the skill assessment and the learning profiles created with the skills assessment. The learning profile provided to the student may reflect all or some of the information about the student determined using the skill assessment.

A student may apply to the educational program through any suitable means and the student will be recorded as a prospective applicant to the program. During a time after the student has applied to the program and before the student has started the educational program, the student will be notified to complete the skill assessment. This notification may also be triggered by the acceptance of payment from the student for the educational program. The student may be labeled as “Upcoming” or given any other suitable designation. In some examples, the student may be able to complete the skill assessment before applying to the educational program. A student who has applied to the educational program may be recorded in a system as being ready to take the skill assessment. An account may be associated with the student, in order to keep track of the students status, such as if they have completed their application or if they have taken the skill assessment. This could be processed in a Customer Relationship Management (CRM) program, or any other suitable system.

When the condition is met for the student to take the skill assessment, the student may be notified to complete the skill assessment. This notification may come in any form, but may be an automated email or a text message in some examples. If the student is at a location with a representative of the educational program, the student may be told in person that they can take the skill assessment. The notification for the student to take the skill assessment may be associated with the students account. The notification, such as an email or a text message, may include a link to a webpage leading to the skill assessment and may also include instructions for completing the skill assessment. The notification may also include instructions for completing a general new student survey, which can allow other relevant information to be gathered from the student that is not part of the skill assessment. The skill assessment may be provided in any type of electronic format that is suitable, including being hosted on a website or being navigated trough on multiple webpages. In a specific example, the skill assessment may be hosted on TypeForm. When a student has completed the skill assessment the data provided by the student and including the results of the skill assessment may be saved or exported in any suitable format, such as a csv file. The exported data and results of the skill assessment may include the logic and information necessary to evaluate the results.

The exported or saved data from the completed skill assessment may be evaluated to review the results, such as to verify that the information has been transferred correctly and the answers are consistent. In some embodiments, a human may review a portion of the data, while in many embodiments the data will be reviewed automatically and/or electronically except where human review may be warranted, such as where a review application is unable to determine results or interpret responses. The results can be analyzed using any of a number of applications or algorithms to determine an educational state, or other such metric, of the user. In at least one embodiment, the assessment information can be provided as input to a trained machine learning model to infer the educational state and/or courses or training to recommend to the user. Based at least in part on the results of the skill assessment, a message can be sent to the student with detailing some or all of the results and providing one or more recommendations. The message may be an email or a text message, or the information of the message may be provided to the student from a person associated with the educational program. Additionally, in some instances, if the student does not complete the skill assessment within a certain amount of time from the when the notification to take the skill assessment is received, the student may be notified again to complete the skill assessment. The amount of time until for the student to complete the assessment may be any length that is suitable. In one example, the length of time may be three days, while in another example it may be seven days. Additionally, a person associated with the educational program may be notified if the student does not complete the assessment within the required amount of time, and may notify the student themselves. In an alternative example, an electronic message may be sent to the student, such as an email or a text message. In circumstances where the student has completed the skill assessment and is recommended to take a preparatory course, but the full-time program has ready streamline to enroll in the preparatory course has already passed, the student may be notified via a suitable method that they should enroll in the next available preparatory program.

The results of the skill assessment that is sent to the student in regards to the preparatory course recommendation can take one of several forms. First, the student may be notified that they do not need to take a preparatory course. In another instance, the student may be notified that they need to take a preparatory course, and can enroll in the immediately upcoming cohort, or group of programs. In an alternative instance, the student may be notified that they need to take a preparatory course, but will need to defer to the next available cohort. Finally, the student may be notified that they should complete the skill assessment after the upcoming cohort start date.

The preparatory courses recommended to the student based on the skills assessment may have one or more differences or share one or more common elements. For instance, one preparatory course may be live and hosted in person or on-line, while the other preparatory course is self-paced and self-taught. However, both courses are meant to prepare the student for the offered full-time educational program. Additionally, both courses may generally teach the same subject matter, require the same amount of participation by the student, and take the same amount of total time to complete. In certain instances, some or all of these features may be different. Different preparatory course are generally targeted to different student audiences. For instance, one course may be targeted toward students with some experience, but who need some extra support. Another preparatory course may be for students with some experience or a clear aptitude for learning in the style used to teach in the full-time educational program. Additionally, all student may be given access to the subject matter taught in the preparatory courses, even if the student does not receive a recommendation to participate in a preparatory course before starting the full-time educational program.

The skill assessment can be an objective, item-based assessment. Other than the name and contact information of the student, all data collected by the skill assessment may be through an objective, item-based assessment. Utilizing only objective assessment questions, instead of subjective assessment questions, improves the reliability and consistency of the skill assessment. The skill assessment may include any number of questions or prompts for answers from the student. Included with each of the questions or prompts may be instructions for providing and answer to the question or prompt, and also included are the options provided to answer each of the questions or prompts. The questions types for the skill assessment may include ranking questions, single select questions, and multiple select questions, as well as any other suitable question types. The options types for providing an answer may therefore include ranking answers, single select answers, and multiple select answers, or any other suitable answer types.

As previously mentioned, the skill assessment can be utilized to determine if a student should participate in a preparatory course before starting a full-time educational program. In one example, a passing level for the computer skills category and a passing level for the program specific aptitude categories of the skill assessment are the basis for the recommendation for the preparatory course for the student. Similarly, the detailed learning guide recommendation for the student may be based on the results of the learning catalytic skills, learning processing preference, and the learning content preference. Depending on the type of program the student has applied to, certain combinations of categories from the skill assessment can be used for specific recommendations.

The assessment can include any number of questions suitable to identify the content and learning needs of the student. For example, the assessment may include five questions or over two hundred question. In another example, the assessment may include exactly eighty three questions. The number of questions in the assessment may be expected to be completed in a certain amount of time. For instance, the assessment may be expected to take five minutes to compete or over two hours to complete. In another example, the assessment may take approximately thirty minutes for most students to provide the required information. It is also considered that the number of questions may change while the assessment is being taken, increasing or decreasing the number of questions based on the students answers.

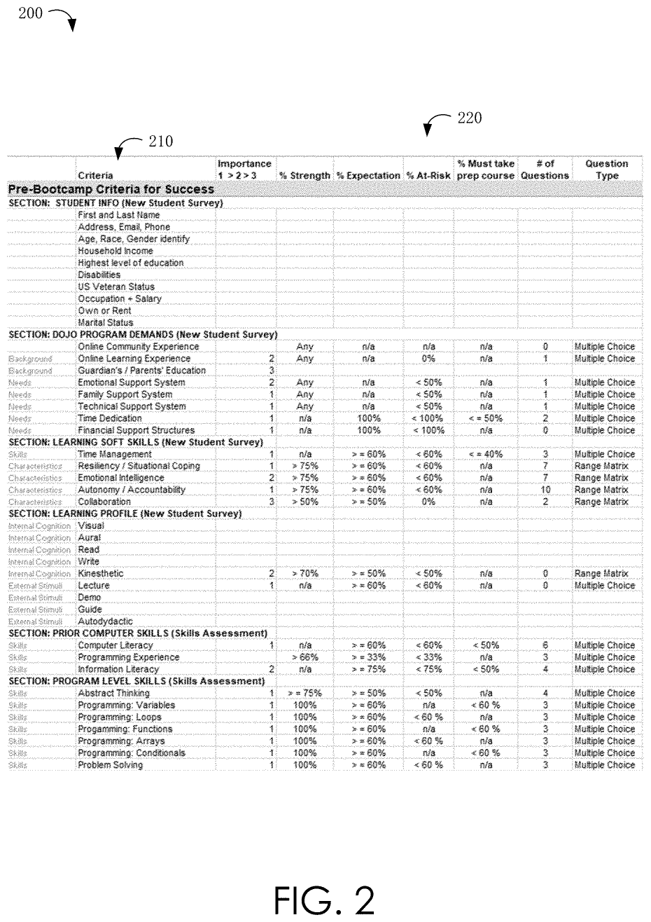

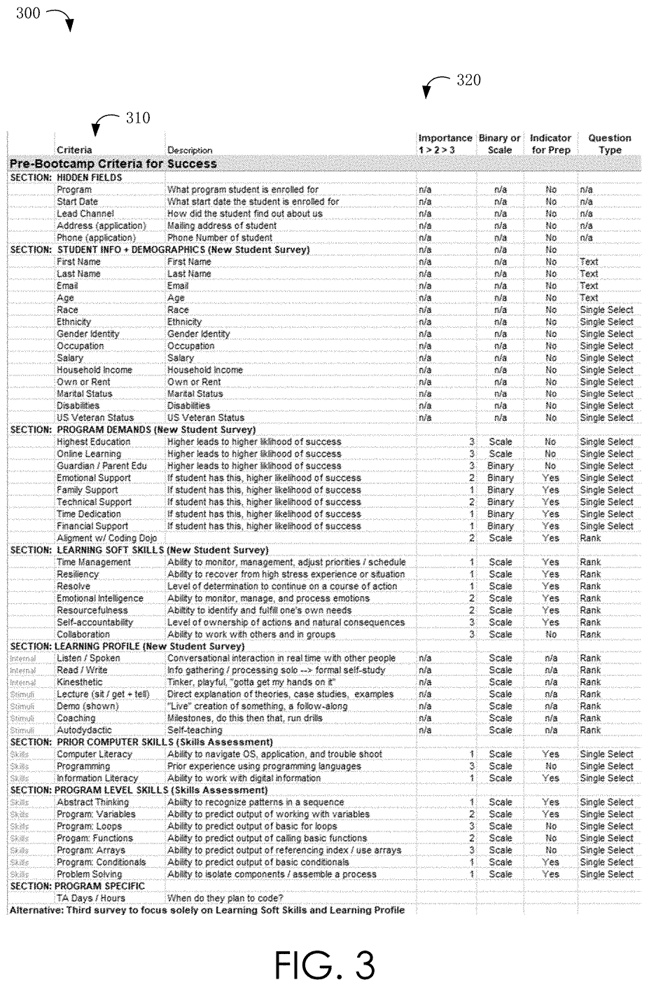

FIGS. 2 and 3 show two example sets of skill assessment indicators and weights 200 and 300. In at least one embodiment, answers to some questions or answers to some groups of questions of the skills assessment may be weighted more or less than other questions or group of questions. The weighing of the answers may be used to more accurately determine whether a student needs to take a preparatory course before beginning the full-time learning program, and if so, which preparatory course. Or in other embodiments, the weighting maybe used to more accurately determine the relevant option for the individual. Additionally, the weighing system of the assessment can be updated based on the needs of the system in order to better place students, and/or to improve the validity and reliability of the assessment. In certain versions, weighing may only apply to the answers of the skills assessment questions. In other versions, weighing may only apply to the answers of the learning styles assessment questions, or both the skills assessment and learning styles questions. Additionally, some questions may be unweighted or may only be weighed depending on the answers provided by the student.

Still referring to FIGS. 2 and 3, each subset of the categories of information may have a set number of questions directly associated with the subset, or the number of questions could change depending on a number of factors. A passing level may be identified for each subset of the categories dependent on the level of importance associated with that subset in regards to the overall success of the program. For example, the passing level of the Collaboration category may be worth more overall than Emotional Support category for a likelihood of success of the student. Depending on the type of program the student has applied to and the goal of the assessment, each category may have a passing level set at a specific level as necessary for the program. Additionally, the passing levels for the categories may be altered to improve the accuracy and reliability of the assessment.

The data collected by the skill assessment can include information from several categories focusing on different criteria 210, 310. For instance, the categories of information collected from a student may include a student's demographics, external support systems, learning catalytic skills profile, learning processing preference, learning content consumption preference, computer skills, and program specific aptitude for the program the student has applied to. In other versions, the assessment may collect additional information about the student, or may not collect information from certain categories. The student's demographics generally includes identifying information such as age, gender identity, race, prior educational experience, etc. computer skills can include information regarding competence in basic computer skills needed for online learning. The learning profile may include the student's preferred style of learning, etc. The learning soft skill may include information such as the student's time management, resiliency, etc. The information gather related to the program demands can include time commitment, financial commitment, etc. Finally, the student's program aptitude and skills will include information relevant to program the student has applied to. Each educational program has its own aptitude and skills measurement designed to assess the knowledge and skills already present for a student to be successful in the content of the program. For example, the software development program will focus on a collection of Programming Aptitude, Abstract Thinking, and Problem Solving. The skill assessment may also include and be updated with questions about the student circumstances or why they choose the specific educational program. In one example, a question may be added asking whether the pandemic influenced the decision to take an online versus an onsite course. A level of importance 220, 320 may be assigned to any number of criteria 210, 310 along with relevant information percent strength, percent expectation, percent at risk, percent deal breaker, or any other measurement, for each of the criteria.

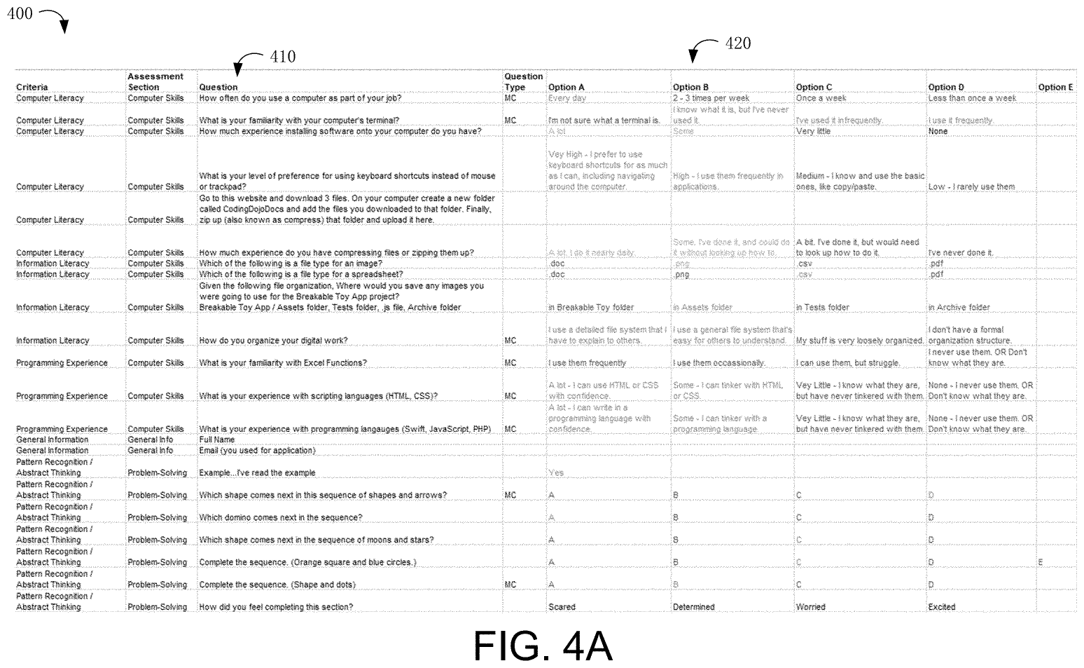

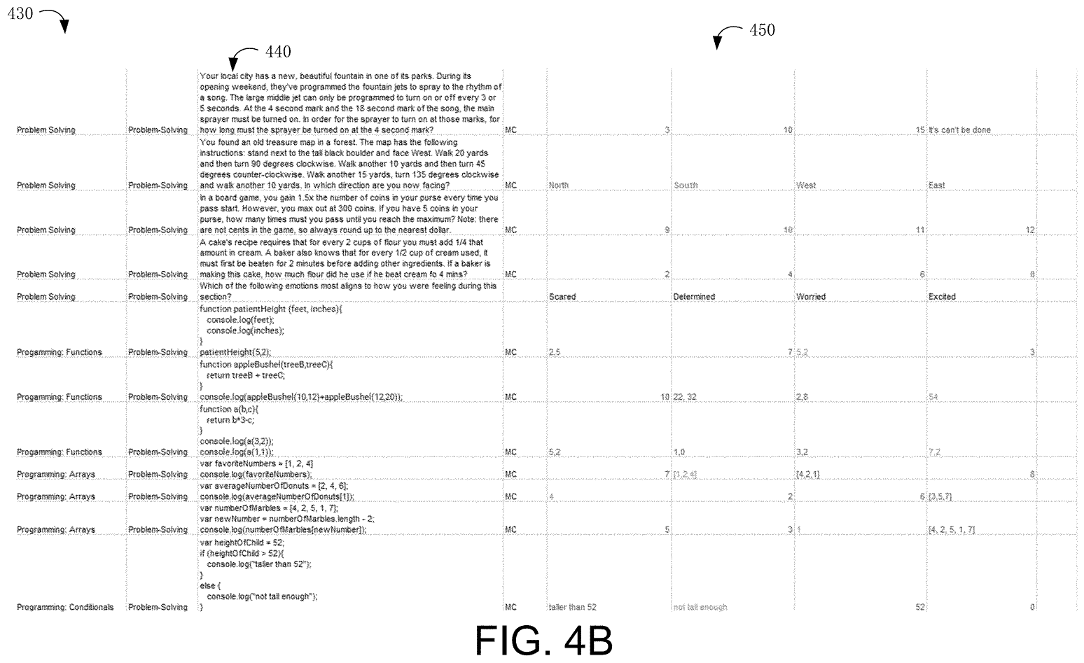

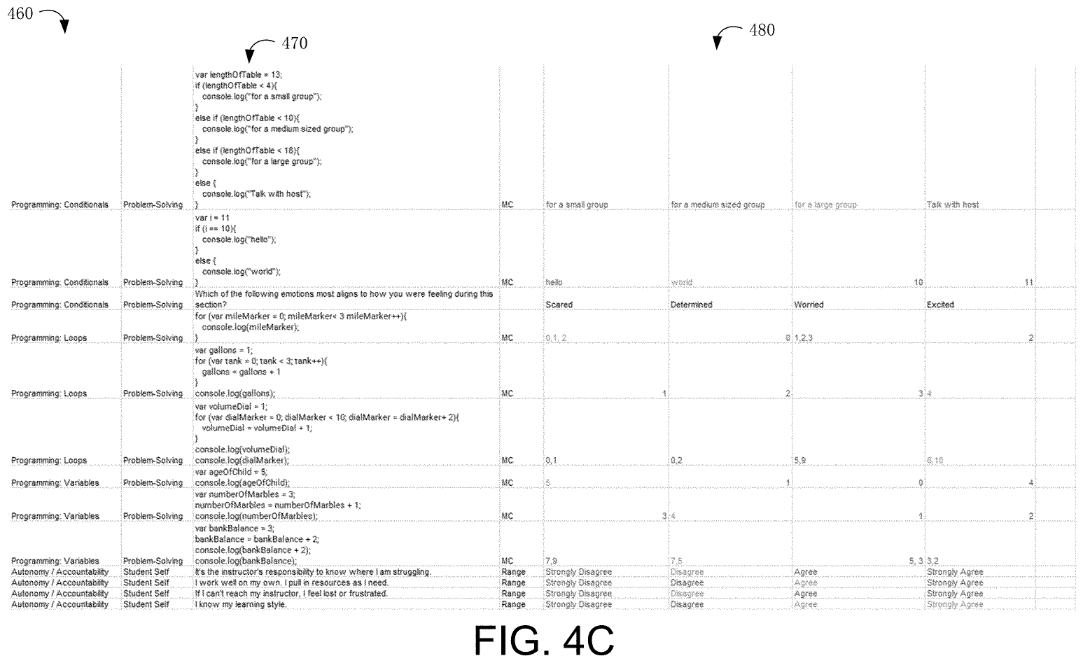

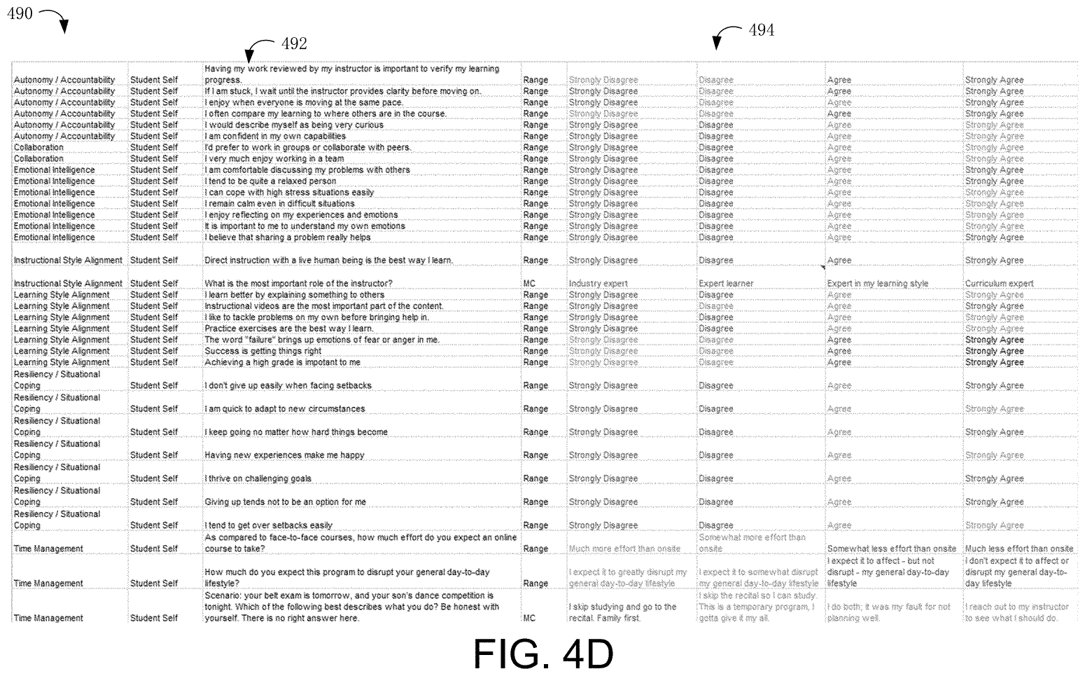

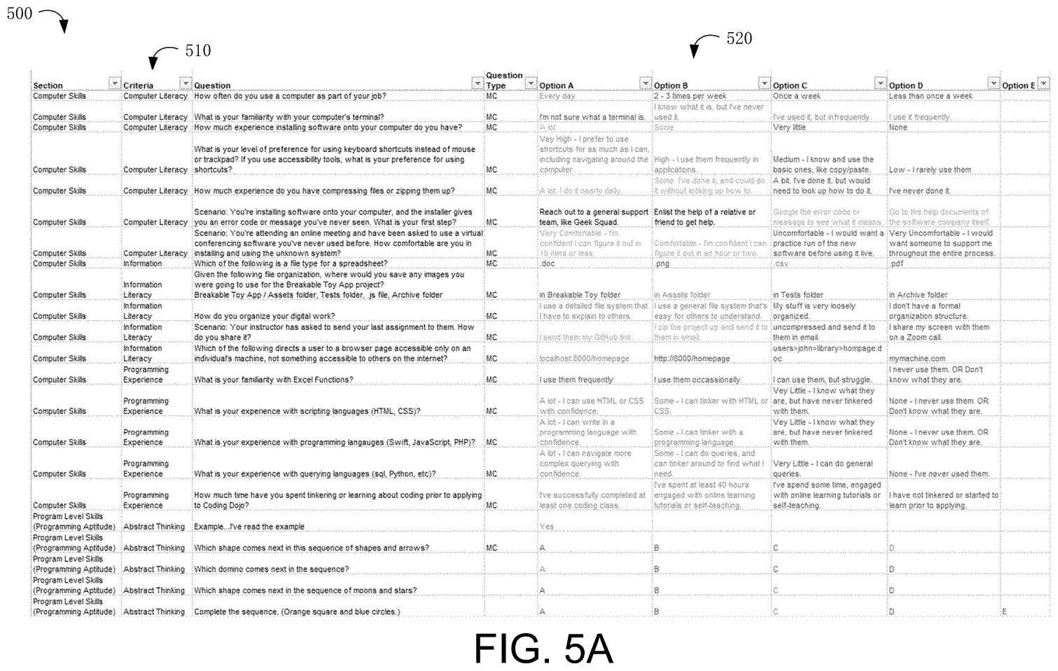

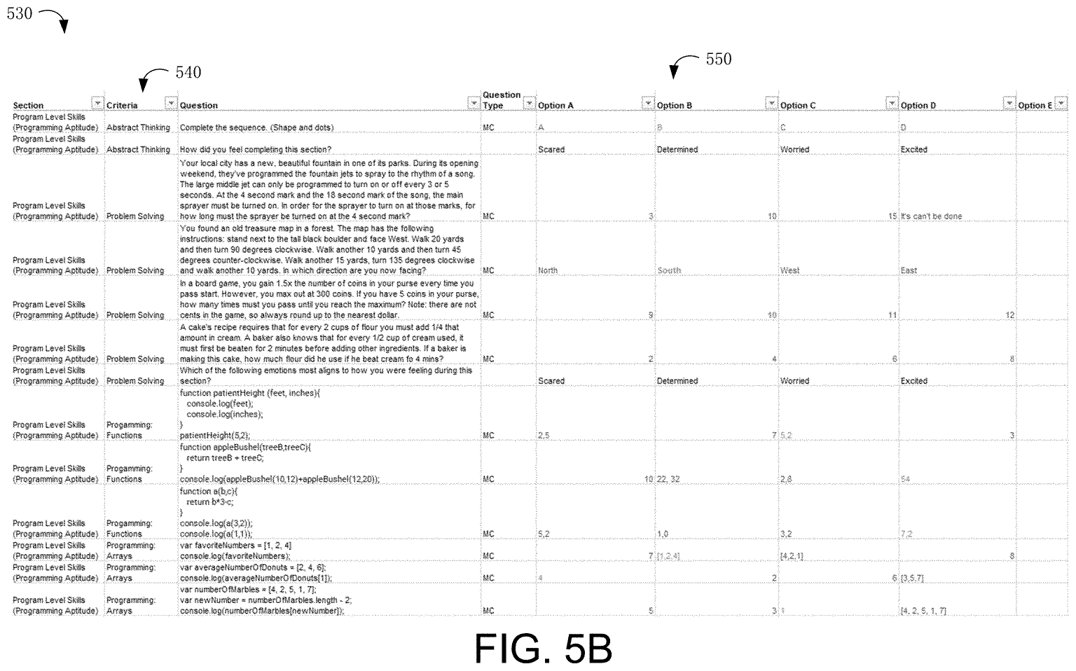

FIGS. 4A, 4B, 4C, and 4D show an example set of skill assessment questions and answers 400, 430, 460, 490 and FIGS. 5A, 5B, and 5C show an alternative example set of skill assessment questions and answers 500, 530, 560. Skill assessment questions and answers 400, 430, 460, 490, 500, 530, 560 may have any number of sets of question 410, 440, 470, 492, 510, 440, 470 and answers 420, 450, 480, 494, 520, 550, 580 in order to properly evaluate a student. A number of questions and answers may belong to certain criteria groups, which can then be used to evaluate a student in that specific criteria. Question and answers may be in any suitable format, such as multiple choice or a range format.

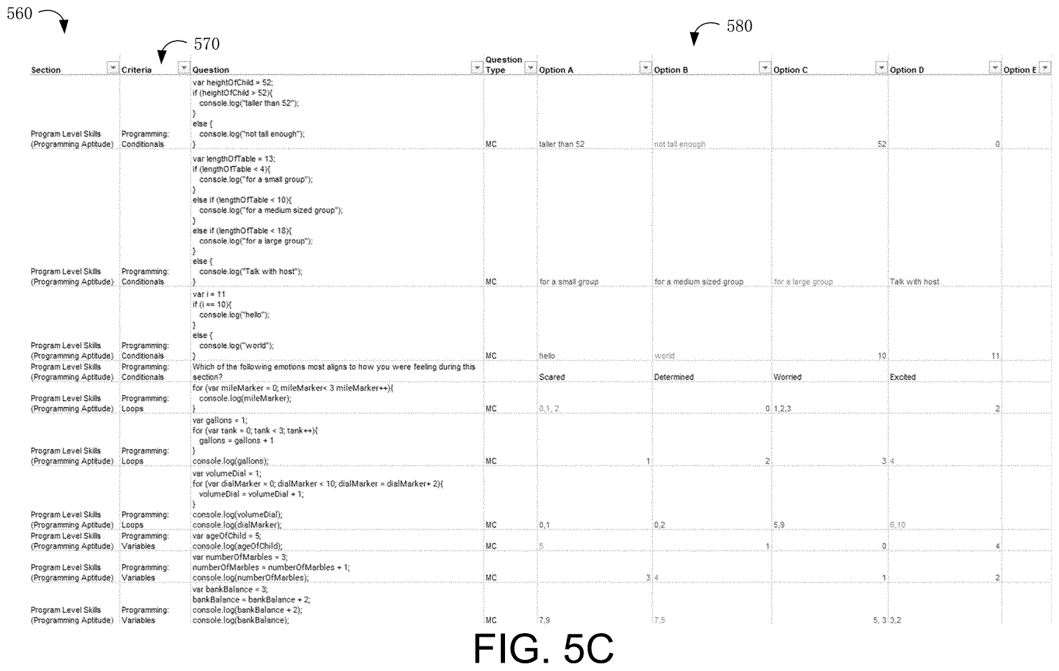

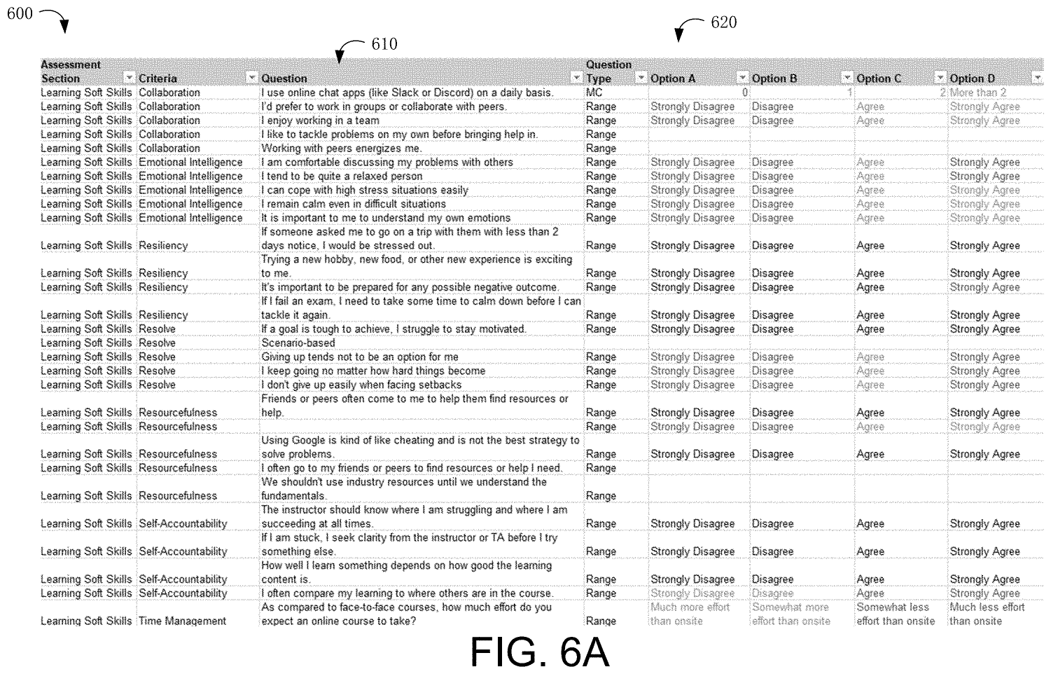

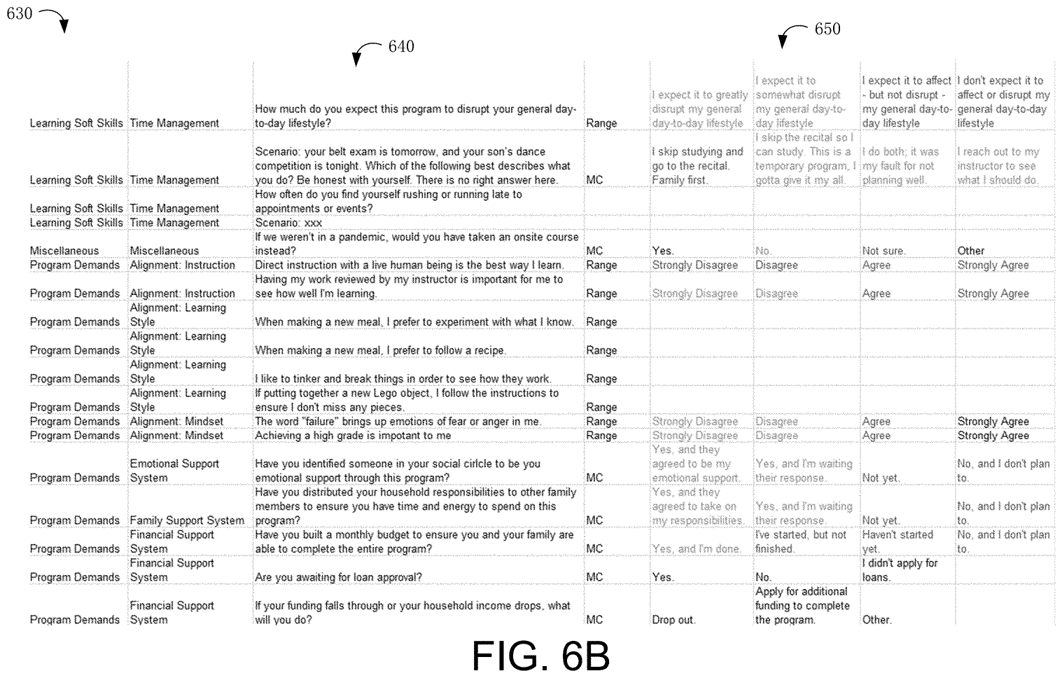

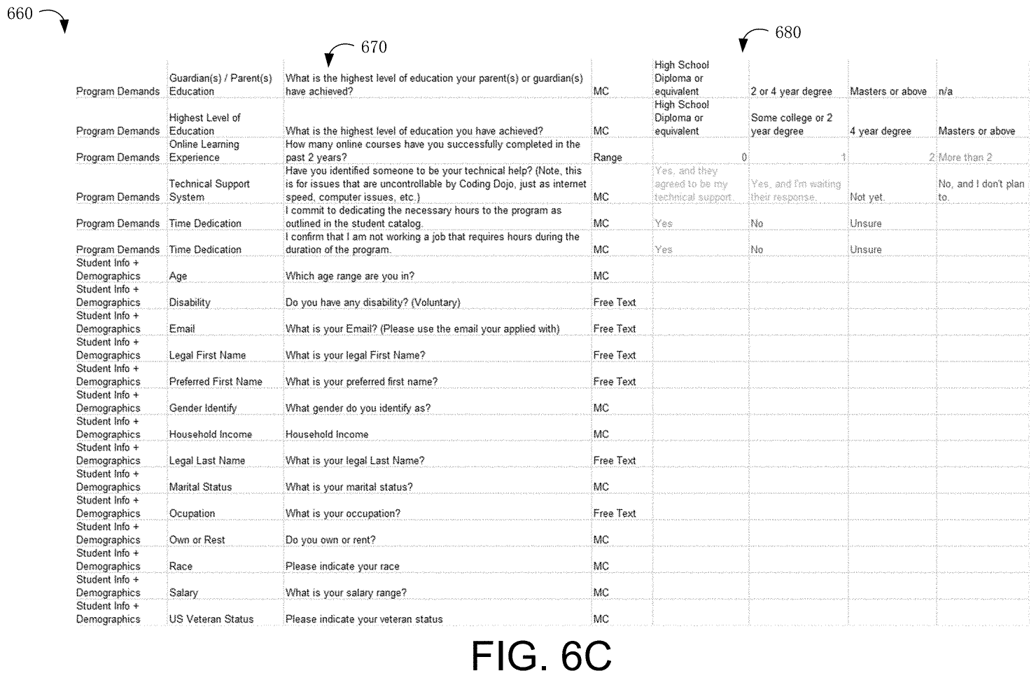

FIGS. 6A, 6B, and 6C show an example set of results 600, 630, 660 of a completed skill assessment survey. The completed set of results 600, 630, 660 will include a chosen set of answers 610, 640, 670 that accompany any number of questions 600, 630, 660. In certain embodiments, all questions must be answered. In other embodiments, each questions may not require an answer. The answer may be provided in any suitable format, which may be set prior to answering. In order to determine the results for the completed skill assessment, a number of the answers will be identified and evaluated. Each of the questions and answers may be associated with a category or criteria in order to evaluate the criteria using the relevant questions and answers.

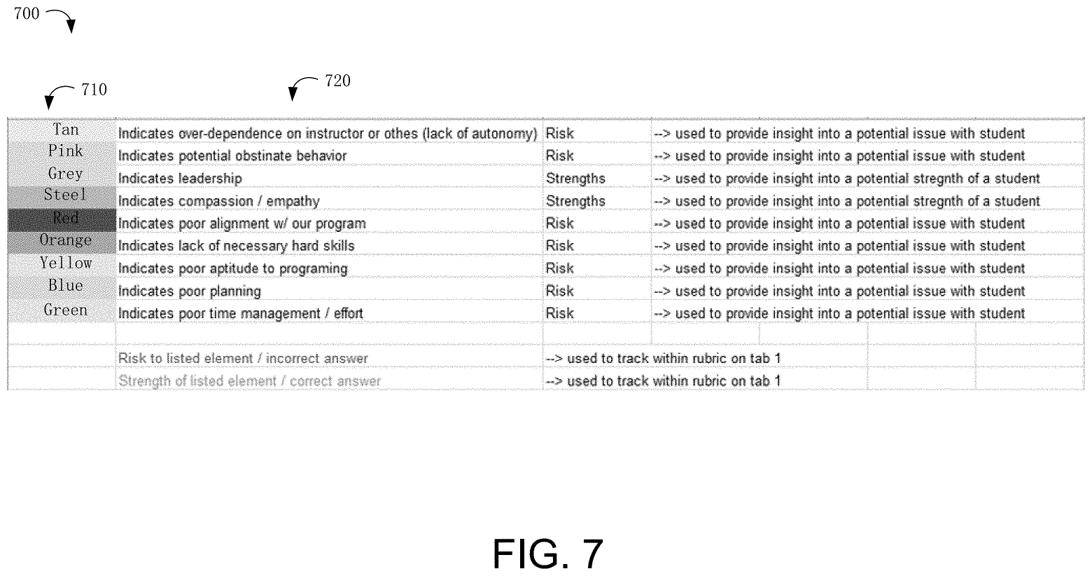

FIG. 7 show an example skill assessment color legend 700. As shown, individual colors 710, or any suitable identifier, is applied to each area of risk or strengths 720, or any other category that is to be monitored. The selected colors allow for efficient and rapid analysis of results. Depending on the individual categories to be analyzed, they can be used to provide insight to potential issues with the student, strengths of the student, or any other relevant metric.

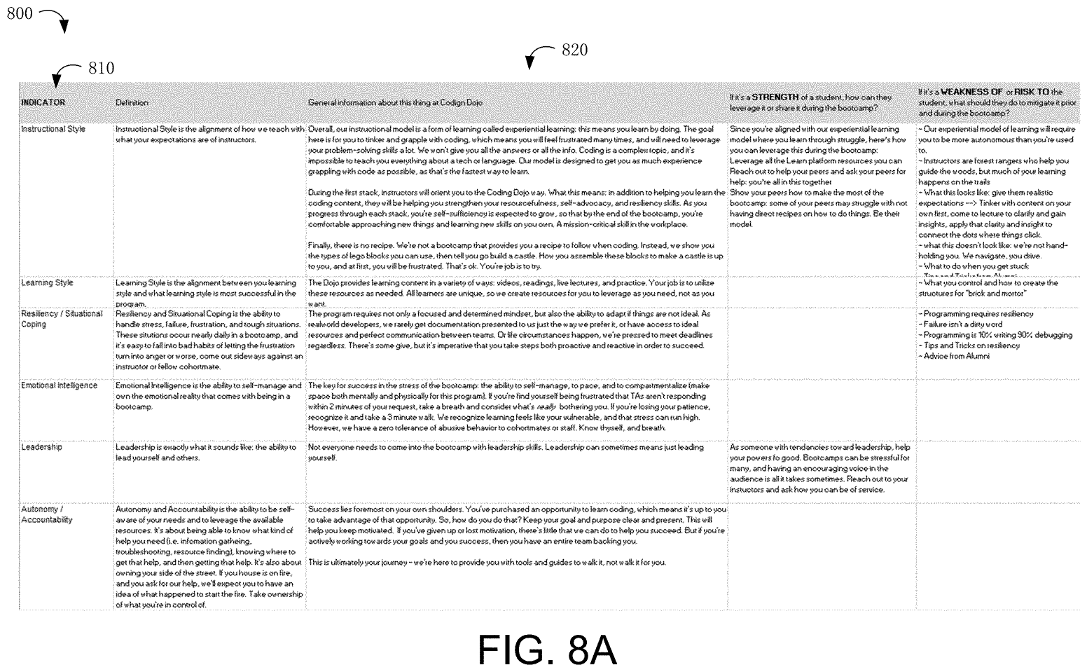

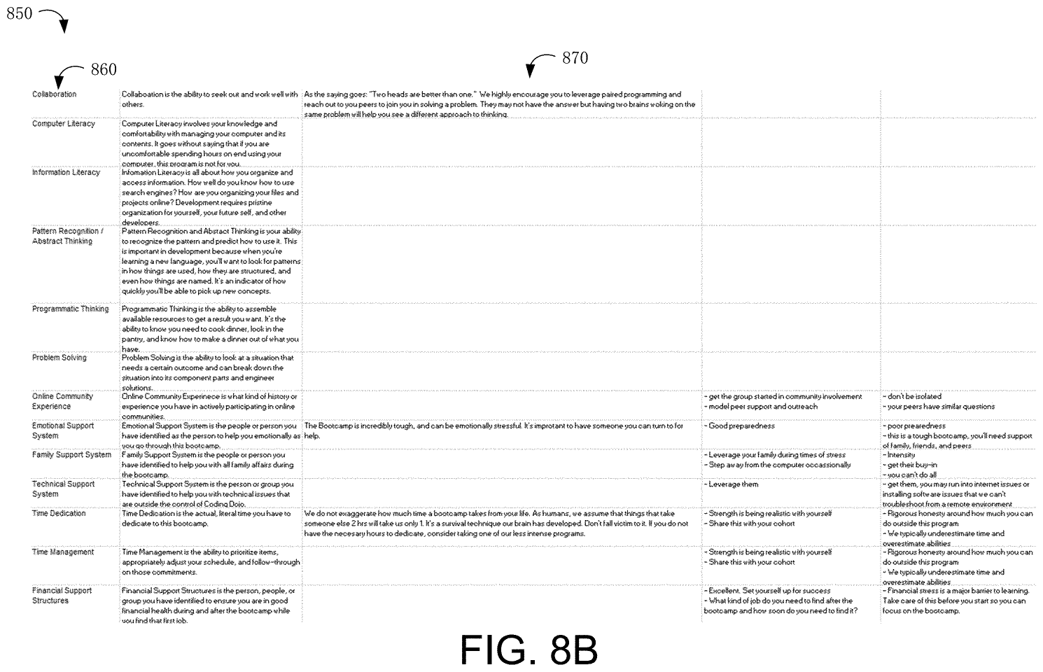

FIGS. 8A and 8B show an example set of skill assessment strengths and risks language 800, 850. A set of skill assessment strengths and risks language 800 may include any number of indicators 810, 860 that can be determined using the assessment. Indicators may be any relevant quality that is desired to be analyzed for a student. Indicators can be used to determine the likelihood of success of a student and/or to determine a student's strengths and weaknesses. In the example shown, the indicators include Instructional Style, Learning Style, Resiliency/Situational Coping, Emotional Intelligence, Leadership, Autonomy/Accountability, Collaboration, Computer Literacy, Information Literacy, Pattern Recognition/Abstract Thinking, Programmatic Thinking, Problem Solving, Online Community Experience, Emotional Support System, Family Support System, Technical Support System, Time Dedication, Time Management, and Financial Support Structures. Additionally, as shown in FIGS. 8A and 8B, descriptions and relevance 820, 870 may be provided for each indicator.

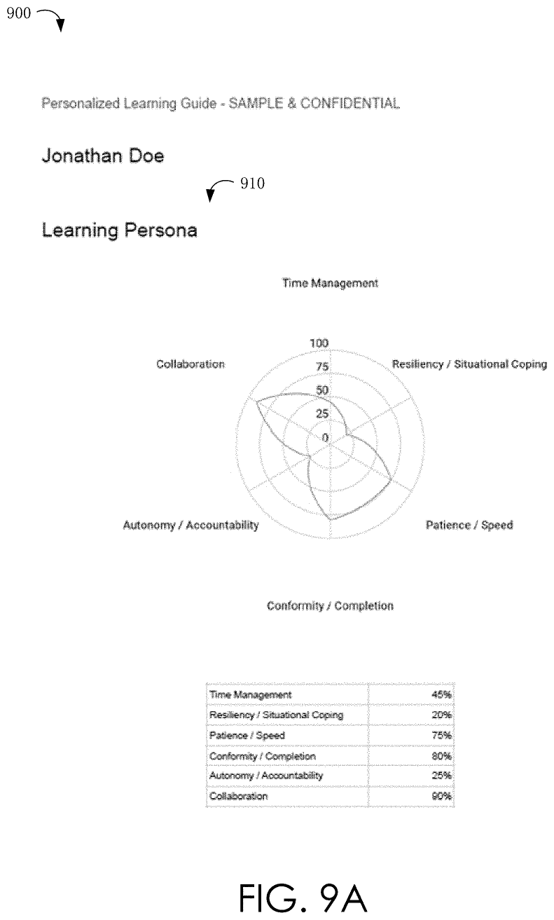

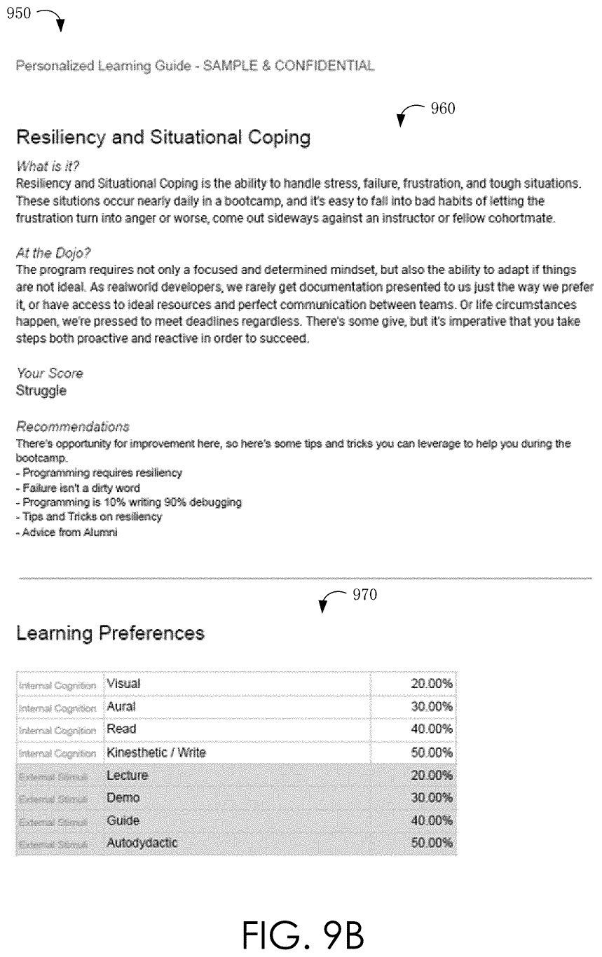

FIGS. 9A and 9B shows an example personalized report based on the results of a student's completed assessment. As shown in FIG. 9A, personalized report includes a learning profile 900 and a detailed learning guide 950. As shown, learning profile 900 includes details regarding the student's learning persona 910 determined based on the completed skill assessment. Learning persona 910 may include details regarding qualities such as Time Management, Resiliency/Situational Coping, Patience/Speed, Autonomy/Accountability, and Collaboration, or any other quality that is desired to be measured. Learning persona 910 may be presented in any suitable form, such as graphical, numerical, and/or written.

As shown in FIG. 9B, detailed learning guide 950 may include a detailed description 960 of qualities from the learning persona 910. The detailed description of detailed learning guide 950 may include descriptions of a specific quality, the relevancy of the quality to the program, the student's score relevant to the quality, and related recommendations for the student. Any other relevant information may be included with or instead of these descriptions, and descriptions may be presented in any suitable form, such as graphical, numerical, and/or written. Any number of detailed learning guides may be provided to the student, such as a separate detailed learning guide for each quality. In some instances, a student's learning preferences 970 may be presented in a detailed learning guide. Learning preference may be presented with information related to learning styles such as Internal Cognition, External Cognition, or may be related to any information relevant to the student. Any number of areas, categories, or measure may be presented, and may be presented in any suitable form, such as graphical, numerical, and/or written.

In one or more embodiments, a computerized environment such as that in FIG. 1 may include various resources that can be utilized by users for a variety of purposes. As used herein, computing and other electronic resources utilized in a network environment can be referred to as “network resources.” These can include, for example, servers, databases, load balancers, routers, and the like, which can perform tasks such as to receive, transmit, and/or process data and/or executable instructions. In one or more embodiments, all or a portion of a given resource or set of resources might be allocated to a particular user or allocated for a particular task, for at least a determined period of time. The sharing of these multi-tenant resources from a provider environment is often referred to as resource sharing, Web services, or “cloud computing,” among other such terms and depending upon the specific environment and/or implementation. In one example the provider environment includes a plurality of resources of one or more types. These types can include, for example, application servers operable to process instructions provided by a user or database servers operable to process data stored in one or more data stores in response to a user request. As known for such purposes, a user can also reserve at least a portion of the data storage in a given data store. Methods for enabling a user to reserve various resources and resource instances are well known in the art, such that detailed description of the entire process, and explanation of all possible components, will not be discussed in detail herein.

A resource manager, or another such system or service, in this example can also function as a virtual layer of hardware and software components that handles control functions in addition to management actions, as may include provisioning, scaling, replication, etc. The resource manager can utilize dedicated APIs in the interface layer, where each API can be provided to receive requests for at least one specific action to be performed with respect to the data environment, such as to provision, scale, clone, or hibernate an instance. Upon receiving a request to one of the APIs, a Web services portion of the interface layer can parse or otherwise analyze the request to determine the steps or actions needed to act on or process the call. For example, a Web service call might be received that includes a request to create a data repository.

An interface layer in at least one embodiment includes a scalable set of user-facing servers that can provide the various APIs and return the appropriate responses based on the API specifications. The interface layer also can include at least one API service layer that in one embodiment consists of stateless, replicated servers which process the externally-facing user APIs. The interface layer can be responsible for Web service front end features such as authenticating users based on credentials, authorizing the user, throttling user requests to the API servers, validating user input, and marshalling or unmarshalling requests and responses. The API layer also can be responsible for reading and writing database configuration data to/from the administration data store, in response to the API calls. In many embodiments, the Web services layer and/or API service layer will be the only externally visible component, or the only component that is visible to, and accessible by, users of the control service. The servers of the Web services layer can be stateless and scaled horizontally as known in the art. API servers, as well as the persistent data store, can be spread across multiple data centers in a region, for example, such that the servers are resilient to single data center failures.

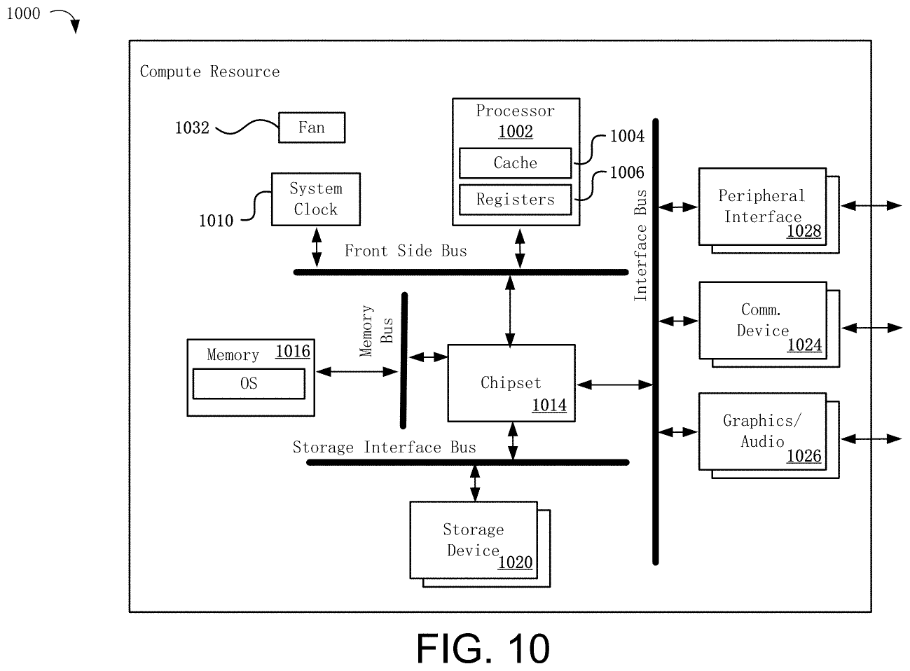

Computing resources, such as servers or personal computers, will generally include at least a set of standard components configured for general purpose operation, although various proprietary components and configurations can be used as well within the scope of the various embodiments. FIG. 10 illustrates components of an example computing resource 1000 that can be utilized in accordance with various embodiments. It should be understood that there can be many such compute resources and many such components provided in various arrangements, such as in a local network or across the Internet or “cloud,” to provide compute resource capacity as discussed elsewhere herein. The computing resource 1000 (e.g., a desktop or network server) will have one or more processors 1002, such as central processing units (CPUs), graphics processing units (GPUs), and the like, that are electronically and/or communicatively coupled with various components using various buses, traces, and other such mechanisms. A processor 1002 can include memory registers 1006 and cache memory 1004 for holding instructions, data, and the like. In this example, a chipset 1014, which can include a northbridge and southbridge in some embodiments, can work with the various system buses to connect the processor 1002 to components such as system memory 1016, in the form or physical RAM or ROM, which can include the code for the operating system as well as various other instructions and data utilized for operation of the computing device. The computing device can also contain, or communicate through a storage interface bus with, one or more storage devices 1020, such as hard drives, flash drives, optical storage, and the like, for persisting data and instructions similar, or in addition to, those stored in the processor and memory. The processor 1002 can also communicate with various other components via the chipset 1014 and an interface bus (or graphics bus, etc.), where those components can include communications devices 1024 such as cellular modems or network cards, media components 1026, such as graphics cards and audio components, and peripheral interfaces 1028 for connecting peripheral devices, such as printers, keyboards, and the like. At least one cooling fan 1032 or other such temperature-regulating or reduction component can also be included as well, which can be driven by the processor or triggered by various other sensors or components on, or remote from, the device. A system clock 1010 may also be connected with the processor 1002 and the chipset 1014 through the front side bus. Various other or alternative components and configurations can be utilized as well as known in the art for computing devices.

At least one processor 1002 can obtain data from physical memory 1016, such as a dynamic random access memory (DRAM) module, via a coherency fabric in some embodiments. It should be understood that various architectures can be utilized for such a computing device, that may include varying selections, numbers, and arguments of buses and bridges within the scope of the various embodiments. The data in memory may be managed and accessed by a memory controller, such as a DDR controller, through the coherency fabric. The data may be temporarily stored in a processor cache 1004 in at least some embodiments. The computing device 1000 can also support multiple I/O devices using a set of I/O controllers connected via an I/O bus. There may be I/O controllers to support respective types of I/O devices, such as a universal serial bus (USB) device, data storage (e.g., flash or disk storage), a network card, a peripheral component interconnect express (PCIe) card or interface 1028, a communication device 1024, a graphics or audio card 1026, and a direct memory access (DMA) card, among other such options. In some embodiments, components such as the processor, controllers, and caches can be configured on a single card, board, or chip (i.e., a system-on-chip implementation), while in other embodiments at least some of the components may be located in different locations, etc.

An operating system (OS) running on the processor 1002 can help to manage the various devices that may be utilized to provide input to be processed. This can include, for example, utilizing relevant device drivers to enable interaction with various I/O devices, where those devices may relate to data storage, device communications, user interfaces, and the like. The various I/O devices will typically connect via various device ports and communicate with the processor and other device components over one or more buses. There can be specific types of buses that provide for communications according to specific protocols, as may include peripheral component interconnect) PCI or small computer system interface (SCSI) communications, among other such options. Communications can occur using registers associated with the respective ports, including registers such as data-in and data-out registers. Communications can also occur using memory-mapped I/O, where a portion of the address space of a processor is mapped to a specific device, and data is written directly to, and from, that portion of the address space.

Such a device may be used, for example, as a server in a server farm or data warehouse. Server computers often have a need to perform tasks outside the environment of the CPU and main memory (i.e., RAM). For example, the server may need to communicate with external entities (e.g., other servers) or process data using an external processor (e.g., a General Purpose Graphical Processing Unit (GPGPU)). In such cases, the CPU may interface with one or more I/O devices. In some cases, these I/O devices may be special-purpose hardware designed to perform a specific role. For example, an Ethernet network interface controller (NIC) may be implemented as an application specific integrated circuit (ASIC) comprising digital logic operable to send and receive messages, such as datagrams.

In an illustrative embodiment, a host computing device is associated with various hardware components, software components and respective configurations that facilitate the execution of I/O requests. One such component is an I/O adapter that inputs and/or outputs data along a communication channel. In one aspect, the I/O adapter device can communicate as a standard bridge component for facilitating access between various physical and emulated components and a communication channel. In another aspect, the I/O adapter device can include embedded microprocessors to allow the I/O adapter device to execute computer executable instructions related to the implementation of management functions or the management of one or more such management functions, or to execute other computer executable instructions related to the implementation of the I/O adapter device. In some embodiments, the I/O adapter device may be implemented using multiple discrete hardware elements, such as multiple cards or other devices. A management controller can be configured in such a way to be electrically isolated from any other component in the host device other than the I/O adapter device. In some embodiments, the I/O adapter device is attached externally to the host device. In some embodiments, the I/O adapter device is internally integrated into the host device. Also in communication with the I/O adapter device may be an external communication port component for establishing communication channels between the host device and one or more network-based services or other network-attached or direct-attached computing devices. Illustratively, the external communication port component can correspond to a network switch, sometimes known as a Top of Rack (“TOR”) switch. The I/O adapter device can utilize the external communication port component to maintain communication channels between one or more services and the host device, such as health check services, financial services, and the like.

The I/O adapter device can also be in communication with a Basic Input/Output System (BIOS) component. The BIOS component can include non-transitory executable code, often referred to as firmware, which can be executed by one or more processors and used to cause components of the host device to initialize and identify system devices such as the video display card, keyboard and mouse, hard disk drive, optical disc drive and other hardware. The BIOS component can also include or locate boot loader software that will be utilized to boot the host device. For example, in one embodiment, the BIOS component can include executable code that, when executed by a processor, causes the host device to attempt to locate Preboot Execution Environment (PXE) boot software. Additionally, the BIOS component can include or takes the benefit of a hardware latch that is electrically controlled by the I/O adapter device. The hardware latch can restrict access to one or more aspects of the BIOS component, such controlling modifications or configurations of the executable code maintained in the BIOS component. The BIOS component can be connected to (or in communication with) a number of additional computing device resources components, such as processors, memory, and the like. In one embodiment, such computing device resource components may be physical computing device resources in communication with other components via the communication channel. The communication channel can correspond to one or more communication buses, such as a shared bus (e.g., a front side bus, a memory bus), a point-to-point bus such as a PCI or PCI Express bus, etc., in which the components of the bare metal host device communicate. Other types of communication channels, communication media, communication buses or communication protocols (e.g., the Ethernet communication protocol) may also be utilized. Additionally, in other embodiments, one or more of the computing device resource components may be virtualized hardware components emulated by the host device. In such embodiments, the I/O adapter device can implement a management process in which a host device is configured with physical or emulated hardware components based on a variety of criteria. The computing device resource components may be in communication with the I/O adapter device via the communication channel. In addition, a communication channel may connect a PCI Express device to a CPU via a northbridge or host bridge, among other such options.

In communication with the I/O adapter device via the communication channel may be one or more controller components for managing hard drives or other forms of memory. An example of a controller component can be a SATA hard drive controller. Similar to the BIOS component, the controller components can include or take the benefit of a hardware latch that is electrically controlled by the I/O adapter device. The hardware latch can restrict access to one or more aspects of the controller component. Illustratively, the hardware latches may be controlled together or independently. For example, the I/O adapter device may selectively close a hardware latch for one or more components based on a trust level associated with a particular user. In another example, the I/O adapter device may selectively close a hardware latch for one or more components based on a trust level associated with an author or distributor of the executable code to be executed by the I/O adapter device. In a further example, the I/O adapter device may selectively close a hardware latch for one or more components based on a trust level associated with the component itself. The host device can also include additional components that are in communication with one or more of the illustrative components associated with the host device. Such components can include devices, such as one or more controllers in combination with one or more peripheral devices, such as hard disks or other storage devices. Additionally, the additional components of the host device can include another set of peripheral devices, such as Graphics Processing Units (“GPUs”). The peripheral devices and can also be associated with hardware latches for restricting access to one or more aspects of the component. As mentioned above, in one embodiment, the hardware latches may be controlled together or independently.

As discussed, different approaches can be implemented in various environments in accordance with the described embodiments. As will be appreciated, although a network- or Web-based environment is used for purposes of explanation in several examples presented herein, different environments may be used, as appropriate, to implement various embodiments. Such a system can include at least one electronic client device, which can include any appropriate device operable to send and receive requests, messages or information over an appropriate network and convey information back to a user of the device. Examples of such client devices include personal computers, cell phones, handheld messaging devices, smartphones, tablets, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server for receiving requests and serving content in response thereto, although for other networks, an alternative device serving a similar purpose could be used, as would be apparent to one of ordinary skill in the art.

The illustrative environment includes at least one application server and a data store. It should be understood that there can be several application servers, layers or other elements, processes or components, which may be chained or otherwise configured, which can interact to perform tasks such as obtaining data from an appropriate data store. As used herein, the term “data store” refers to any device or combination of devices capable of storing, accessing and retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server in the form of HTML, XML or another appropriate structured language in this example. The handling of all requests and responses, as well as the delivery of content between the client device and the application server, can be handled by the Web server. It should be understood that the Web and application servers are not required and are merely example components, as structured code discussed herein can be executed on any appropriate device or host machine as discussed elsewhere herein.

The data store can include several separate data tables, databases or other data storage mechanisms and media for storing data relating to a particular aspect. For example, the data store illustrated includes mechanisms for storing content (e.g., production data) and user information, which can be used to serve content for the production side. The data store is also shown to include a mechanism for storing log or session data. It should be understood that there can be many other aspects that may need to be stored in the data store, such as page image information and access rights information, which can be stored in any of the above listed mechanisms as appropriate or in additional mechanisms in the data store. The data store is operable, through logic associated therewith, to receive instructions from the application server and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device. Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated. Thus, the depiction of the systems herein should be taken as being illustrative in nature and not limiting to the scope of the disclosure.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

In embodiments utilizing a server, the server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Perl, Python or TCL, as well as combinations thereof. The server(s) may also include database servers, including without limitation those commercially available from Oracle®, Microsoft®, Sybase® and IBM® as well as open-source servers such as MySQL, Postgres, SQLite, MongoDB, and any other server capable of storing, retrieving and accessing structured or unstructured data. Database servers may include table-based servers, document-based servers, unstructured servers, relational servers, non-relational servers or combinations of these and/or other database servers.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, magnetic tape drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

At least one embodiment of the disclosure can be described in view of the following clauses:

1. A computer-implemented method, comprising

receiving enrollment information for a user with respect to an educational program;

determining an assessment to be completed by the user based at least in part upon the enrollment information;

analyzing, by at least one computing device, the assessment after completion by the user to infer an educational state of the user;

determining, by the at least one computing device and based in part on the educational state of the user, a compatibility with offerings from the educational program;

providing one or more course recommendations for the user with respect to the educational program; and

enabling the user to enroll in one or more courses in line with the one or more course recommendations.

2. The computer-implemented method of claim 1, wherein the one or more recommendations include at least one of a preparatory course or a learning assistance course to be completed before attending the educational program.

3. The computer-implemented method of claim 2, wherein the preparatory course placement is based on answers provided relating to at least one of computer skills and program specific aptitude

4. The computer-implemented method of claim 2, wherein the preparatory course placement includes one of no preparatory, a self-paced preparatory course, or a live preparatory course.

5. The computer-implemented method of claim 1, further comprising:

sending a notification to the user to complete the assessment.

5. The computer-implemented method of claim 3, wherein the completed assessment is color coded to improve manual review.

6. The computer-implemented method of claim 1, wherein the communication to the student includes a templated populated based on the results of the assessment completed by the student.

8. The computer-implemented method of claim 1, further comprising:

sending a reminder to the student to complete the assessment after a period of time.

9. The computer-implemented method of claim 1, wherein the learning needs is based on answers provided relating to at least one of learning catalytic skills, learning processing preference, and learning content preference.

10. A system, comprising:

a processor; and

memory including instructions that, when executed by the processor, cause the system to:
determine, based on a psychometric assessment completed by a user, one or more recommendations for program offerings and leveraging user qualities, the one or more recommendations determined using at least in part one or more needs and one or more qualities of the user identified by the system from the psychometric assessment.

11. The system of claim 10, further comprising:

receive, from the user, one or more answers to each of the one or more questions of the psychometric assessment.

12. The system of claim 11, further comprising:

assign more or less weight to individual answers of the one or more answers to determine the one or more recommendations.

13. The system of claim 10, wherein one or more questions are grouped into a plurality of categories to determine the one or more recommendations.

14. The system of claim 13, wherein the one or more questions collect data on one or more of:
demographics;
external support systems;
learning catalytic skills profile;
learning processing preference;
learning content consumption preference;
computer skills; and
program specific aptitude.

15. The system of claim 10, wherein the one or more recommendations are provided to the user with a learning profile and one or more detail learning guides.

16. The system of claim 15, wherein the learning profile includes a learning personal for the user presented graphically.

17. The system of claim 15, wherein the one or more detail learning guides include at least one of:

description of a specific quality, relevancy of the specific quality to the program, user's score relevant to the specific quality, and recommendations for the user related to the quality.

18. A non-transitory computer-readable storage medium including instructions that,

when performed by one or more processors, cause the one or more processors to:

determine, based on a psychometric assessment completed by a user, one or more recommendations for program offerings and leveraging user qualities, the one or more recommendations determined using at least in part one or more needs and one or more qualities of the user identified by the one or more processors from the psychometric assessment.

19. The non-transitory computer-readable storage medium of claim 18, wherein the instructions when performed further cause the one or more processors to:

determine one or more recommendations using a weighing of answers provided by the user to the psychometric assessment.

20. The non-transitory computer-readable storage medium of claim 18, wherein the instructions when performed further cause the one or more processors to:

record the one or more recommendations.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or inter-process communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computer-implemented method, comprising receiving enrollment information for a user with respect to an educational program;
determining an assessment to be completed by the user based at least in part upon the enrollment information;
analyzing, by at least one computing device, the assessment after completion by the user to infer an educational state of the user;
determining, by the at least one computing device and based in part on the educational state of the user, a compatibility with offerings from the educational program;
providing one or more course recommendations for the user with respect to the educational program; and
enabling the user to enroll in one or more courses in line with the one or more course recommendations.

2. The computer-implemented method of claim 1, wherein the one or more recommendations include at least one of a preparatory course or a learning assistance course to be completed before attending the educational program.

3. The computer-implemented method of claim 2, wherein the preparatory course placement is based on answers provided relating to at least one of computer skills and program specific aptitude

4. The computer-implemented method of claim 2, wherein the preparatory course placement includes one of no preparatory, a self-paced preparatory course, or a live preparatory course.

5. The computer-implemented method of claim 1, further comprising:
sending a notification to the user to complete the assessment.

5. The computer-implemented method of claim 3, wherein the completed assessment is color coded to improve manual review.

6. The computer-implemented method of claim 1, wherein the communication to the student includes a templated populated based on the results of the assessment completed by the student.

8. The computer-implemented method of claim 1, further comprising:
sending a reminder to the student to complete the assessment after a period of time.

9. The computer-implemented method of claim 1, wherein the learning needs is based on answers provided relating to at least one of learning catalytic skills, learning processing preference, and learning content preference.

10. A system, comprising:
a processor; and
memory including instructions that, when executed by the processor, cause the system to:
determine, based on a psychometric assessment completed by a user, one or more recommendations for program offerings and leveraging user qualities, the one or more recommendations determined using at least in part one or more needs and one or more qualities of the user identified by the system from the psychometric assessment.

11. The system of claim 10, further comprising:
receive, from the user, one or more answers to each of the one or more questions of the psychometric assessment.

12. The system of claim 11, further comprising:
assign more or less weight to individual answers of the one or more answers to determine the one or more recommendations.

13. The system of claim 10, wherein one or more questions are grouped into a plurality of categories to determine the one or more recommendations.

14. The system of claim 13, wherein the one or more questions collect data on one or more of:
demographics;
external support systems;
learning catalytic skills profile;
learning processing preference;
learning content consumption preference;
computer skills; and
program specific aptitude.

15. The system of claim 10, wherein the one or more recommendations are provided to the user with a learning profile and one or more detail learning guides.

16. The system of claim 15, wherein the learning profile includes a learning personal for the user presented graphically.

17. The system of claim 15, wherein the one or more detail learning guides include at least one of:
description of a specific quality, relevancy of the specific quality to the program, user's score relevant to the specific quality, and recommendations for the user related to the quality.

18. A non-transitory computer-readable storage medium including instructions that,
when performed by one or more processors, cause the one or more processors to:
determine, based on a psychometric assessment completed by a user, one or more recommendations for program offerings and leveraging user qualities, the one or more recommendations determined using at least in part one or more needs and one or more qualities of the user identified by the one or more processors from the psychometric assessment.

19. The non-transitory computer-readable storage medium of claim 18, wherein the instructions when performed further cause the one or more processors to:
determine one or more recommendations using a weighing of answers provided by the user to the psychometric assessment.

20. The non-transitory computer-readable storage medium of claim 18, wherein the instructions when performed further cause the one or more processors to:
record the one or more recommendations.
